(19) United States
(12) Patent Application Publication
(10) Pub. No.: US 2026/0104503 A1
(43) Pub. Date: Apr. 16, 2026

(54) ANTENNA SYSTEM, ANTENNA DETECTION METHOD, AND ANTENNA DEVICE

(71) Applicant: WISTRON NEWEB CORPORATION, HSINCHU (TW)

(72) Inventor: YIN-PING WU, HSINCHU (TW)

(21) Appl. No.: 19/063,423

(22) Filed: Feb. 26, 2025

(30) Foreign Application Priority Data
Oct. 16, 2024 (TW) 113139249

(51) Int. Cl. G01S 13/76; H01Q 1/24; H01Q 1/50

(52) U.S. Cl. CPC G01S 13/765; H01Q 1/24; H01Q 1/50

(57) ABSTRACT

An antenna system, an antenna detection method and an antenna device are provided, and the antenna system includes a plurality of antenna pairs, a plurality of transmitter switches, a plurality of receiver switches, and a wireless receiving circuit. Each of the antenna pairs includes a transmitter antenna and a receiver antenna. The transmitter switches are respectively coupled to the transmitter antennas, and the receiver switches are respectively coupled to the receiver antennas. The wireless receiving circuit is coupled to the receiver switches. The plurality of transmitter switches and the plurality of receiver switches are switched sequentially, and the transmitter switch and the receiver switch coupled to the same antenna pair are synchronously switched. The wireless receiving circuit is configured to receive a plurality of wireless signals in sequence, and the wireless signals respectively include a plurality of records of spatial information for multiple areas within a field.

### CROSS-REFERENCE TO RELATED PATENT APPLICATION

This application claims the benefit of priority to Taiwan Patent Application No. 113139249, filed on Oct. 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates the field of communications, and more particularly, to an antenna system, an antenna detection method, and an antenna device.

### BACKGROUND OF THE DISCLOSURE

The technology of Wi-Fi signal sensing is gradually being applied to detect whether there are children sitting inside a vehicle. However, in addition to detecting whether there are children in the vehicle, there is a more practical need to detect the exact position of the children.

A multiple-input multiple-output (MIMO) system is an antenna switching system. Due to the multiple sets of antennas at the input and output ends of the MIMO system, the diversity of Wi-Fi signals in the MIMO system is increased, but the complexity of the algorithm is also increased. Furthermore, the MIMO system cannot obtain precise spatial information within the field, making it impossible to accurately determine the location of the children.

### SUMMARY OF THE DISCLOSURE

In one aspect, the present disclosure provides an antenna system suitable for a field, which includes a plurality of antenna pairs, a plurality of transmitter switches, a plurality of receiver switches, and a wireless receiving circuit. Each of the plurality of antenna pairs includes a transmitter antenna and a receiver antenna. The transmitter switches are respectively coupled to the transmitter antennas, and the receiver switches are respectively coupled to the receiver antennas. The wireless receiving circuit is coupled to the plurality of receiver switches. The plurality of transmitter switches and the plurality of receiver switches are configured to be switched sequentially, and the transmitter switch and the receiver switch coupled to a same antenna pair are synchronously switched. The wireless receiving circuit is configured to sequentially receive a plurality of wireless signals, and the plurality of wireless signals respectively include a plurality of records of spatial information for multiple areas within the field.

In another aspect, the present disclosure provides an antenna detection method suitable for a field, which includes: configuring a plurality of antenna pairs, each antenna pair including a transmitter antenna and a receiver antenna, and the transmitter antenna and the receiver antenna of each antenna pair are respectively coupled to a transmitter switch and a receiver switch; sequentially switching the plurality of transmitter switches and the plurality of receiver switches by synchronously switching the transmitter switch and the receiver switch coupled to a same antenna pair; sequentially transmitting a plurality of wireless signals from the plurality of transmitter antennas to the plurality of receiver antennas; and sequentially receiving a plurality of wireless signals via a wireless receiving circuit, and the plurality of wireless signals respectively include a plurality of records of spatial information for multiple areas within the field.

In yet another aspect, the present disclosure provides an antenna device, which includes a wireless transmitting circuit, a plurality of transmitter switches, and a plurality of transmitter antennas. The plurality of transmitter switches are coupled to the wireless transmitting circuit, and the plurality of transmitter antennas are respectively coupled to the plurality of transmitter switches. The plurality of transmitter switches are configured to be switched sequentially.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a first embodiment of an antenna system according to the present disclosure.

FIG. 2 is a schematic diagram of the main beam of the antenna system in FIG. 1.

FIG. 3 is a flowchart of an embodiment of an antenna detection method according to the present disclosure.

FIG. 4 is a schematic diagram of a second embodiment of an antenna system according to the present disclosure.

FIG. 5 is a schematic diagram of a main beam of the antenna system in FIG. 4.

FIG. 6 is a schematic diagram of a third embodiment of an antenna system according to the present disclosure.

FIG. 7 is a schematic diagram of a main beam of the antenna system in FIG. 6.

FIG. 8 is a schematic diagram of a first embodiment of an antenna device according to the present disclosure.

FIG. 9 is a schematic diagram of a second embodiment of an antenna device according to the present disclosure.

FIG. 10 is a schematic diagram of a third embodiment of an antenna device according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

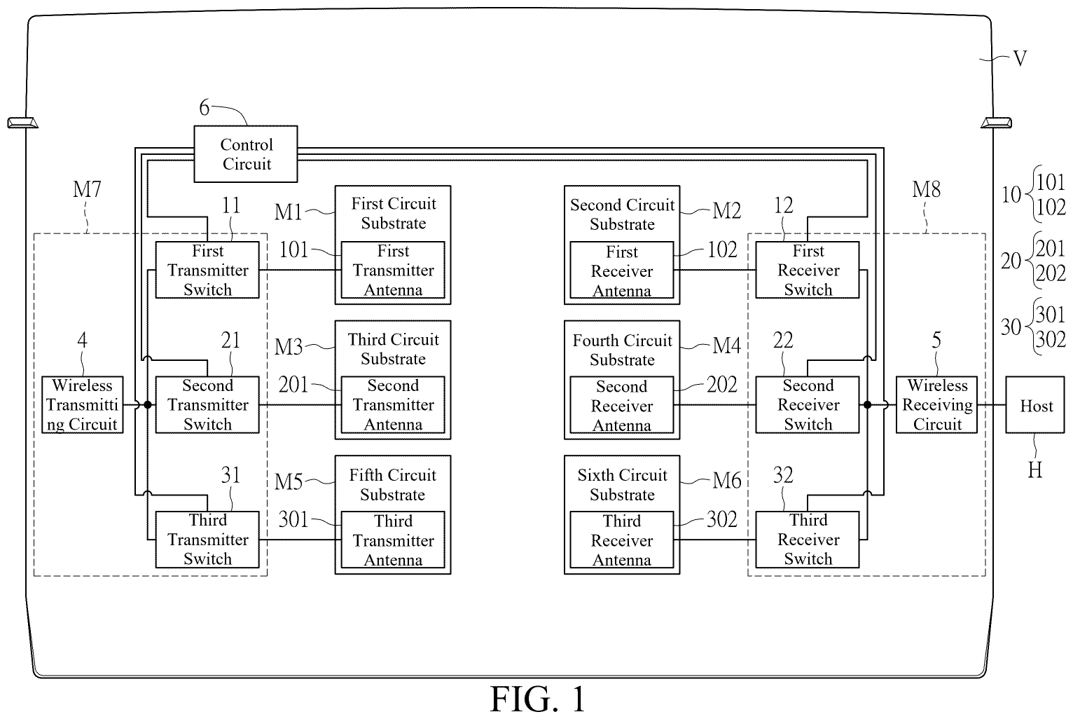

FIG. 1 is a schematic diagram of a first embodiment of an antenna system according to the present disclosure. As shown in FIG. 1, the antenna system includes a first antenna pair 10, a first transmitter switch 11, a first receiver switch 12, a second antenna pair 20, a second transmitter switch 21, a second receiver switch 22, a third antenna pair 30, a third transmitter switch 31, a third receiver switch 32, a wireless transmitting circuit 4, a wireless receiving circuit 5, and a control circuit 6. The antenna system of this embodiment is suitable for fields such as the interior of a vehicle V and is installed on the ceiling of the vehicle V, but the field of application of the antenna system of the present disclosure is not limited thereto. For example, the antenna system of the present disclosure is also suitable for warehouses, offices, conference rooms, or rooms. The first antenna pair 10 includes a first transmitter antenna 101 and a first receiver antenna 102, both of which are directional antennas. A directional antenna is an antenna with directional or angular (directional) characteristics, and generally, the gain of a directional antenna is at least 10 decibels (dBi) or approximately 10 decibels higher than that of a non-directional antenna.

The first transmitter antenna 101 and the first receiver antenna 102 are respectively disposed on a first circuit substrate M1 and a second circuit substrate M2. The first transmitter antenna 101 is coupled to the first transmitter switch 11, and the first receiver antenna 102 is coupled to the first receiver switch 12.

The second antenna pair 20 includes a second transmitter antenna 201 and a second receiver antenna 202, both of which are directional antennas and are respectively disposed on a third circuit substrate M3 and a fourth circuit substrate M4. The second transmitter antenna 201 is coupled to the second transmitter switch 21, and the second receiver antenna 202 is coupled to the second receiver switch 22.

The third antenna pair 30 includes a third transmitter antenna 301 and a third receiver antenna 302, both of which are directional antennas and are respectively disposed on a fifth circuit substrate M5 and a sixth circuit substrate M6. The third transmitter antenna 301 is coupled to the third transmitter switch 31, and the third receiver antenna 302 is coupled to the third receiver switch 32.

Through the shape design of the antennas or the distance configuration between two antennas, the isolation between the first transmitter antenna 101 and the second transmitter antenna 201 is greater than 30 decibels, the isolation between the second transmitter antenna 201 and the third transmitter antenna 301 is greater than 30 decibels, the isolation between the first receiver antenna 102 and the second receiver antenna 202 is greater than 30 decibels, and the isolation between the second receiver antenna 202 and the third receiver antenna 302 is greater than 30 decibels.

The wireless transmitting circuit 4, the first transmitter switch 11, the second transmitter switch 21, and the third transmitter switch 31 are disposed on a seventh circuit substrate M7, and the output end of the wireless transmitting circuit 4 is coupled to the first transmitter switch 11, the second transmitter switch 21, and the third transmitter switch 31. The wireless transmitting circuit 4 may, for example, include a central processing unit, a radio frequency processing circuit, a channel state information capturing circuit, and a network interface.

The wireless transmitting circuit 4 may be, for example, an antenna driving circuit configured to drive the corresponding antenna to transmit wireless signals, such as Wi-Fi signals, Bluetooth signals, or infrared signals. In this embodiment, the wireless signal is a Wi-Fi signal, and the wireless transmitting circuit 4 is a Wi-Fi signal transmitting circuit.

The wireless receiving circuit 5, the first receiver switch 12, the second receiver switch 22, and the third receiver switch 32 are disposed on an eighth circuit substrate M8, and the input end of the wireless receiving circuit 5 is coupled to the first receiver switch 12, the second receiver switch 22, and the third receiver switch 32. The wireless receiving circuit 5 includes a central processing unit, a radio frequency processing circuit, a channel state information capturing circuit, and a network interface.

The wireless transmitting circuit 4 and the wireless receiving circuit 5 may be respectively in station mode and access point mode (AP mode), or respectively in AP mode and station mode.

The wireless receiving circuit 5 is configured to transmit wireless signals. The wireless signals may be Wi-Fi signals, Bluetooth signals, or infrared signals. In this embodiment, the wireless signal is a Wi-Fi signal, and the wireless receiving circuit 5 is a Wi-Fi signal receiving circuit.

The first circuit substrate M1, the third circuit substrate M3, the fifth circuit substrate M5, and the seventh circuit substrate M7 are, for example, installed on the left side of the vehicle ceiling, while the second circuit substrate M2, the fourth circuit substrate M4, the sixth circuit substrate M6, and the eighth circuit substrate M8 are, for example, installed on the right side of the vehicle ceiling.

The control circuit 6 is coupled to the first transmitter switch 11, the first receiver switch 12, the second transmitter switch 21, the second receiver switch 22, the third transmitter switch 31, and the third receiver switch 32. The first transmitter switch 11, the first receiver switch 12, the second transmitter switch 21, the second receiver switch 22, the third transmitter switch 31, and the third receiver switch 32 may be, for example, mechanical switches, solenoid switches, or transistor switches.

The control circuit 6 is configured to sequentially switch the first transmitter switch 11, the second transmitter switch 21, and the third transmitter switch 31 at a plurality of switching times, and the control circuit 6 is configured to sequentially switch the first receiver switch 12, the second receiver switch 22, and the third receiver switch 32 at the plurality of switching times.

Preferably, the plurality of switching times have equal time intervals, in other words, the switching is performed at regular intervals.

The first transmitter switch 11 and the first receiver switch 12 coupled to the first antenna pair 10 are synchronously switched, the second transmitter switch 21 and the second receiver switch 22 coupled to the second antenna pair 20 are synchronously switched, and the third transmitter switch 31 and the third receiver switch 32 coupled to the third antenna pair 30 are synchronously switched.

In addition to achieving synchronous switching of the receiver antenna switch and the transmitter antenna switch through the control circuit 6, in other embodiments, the control circuit 6 can be omitted, and the synchronous switching of the receiver antenna switch and the transmitter antenna switch can be achieved through time synchronization.

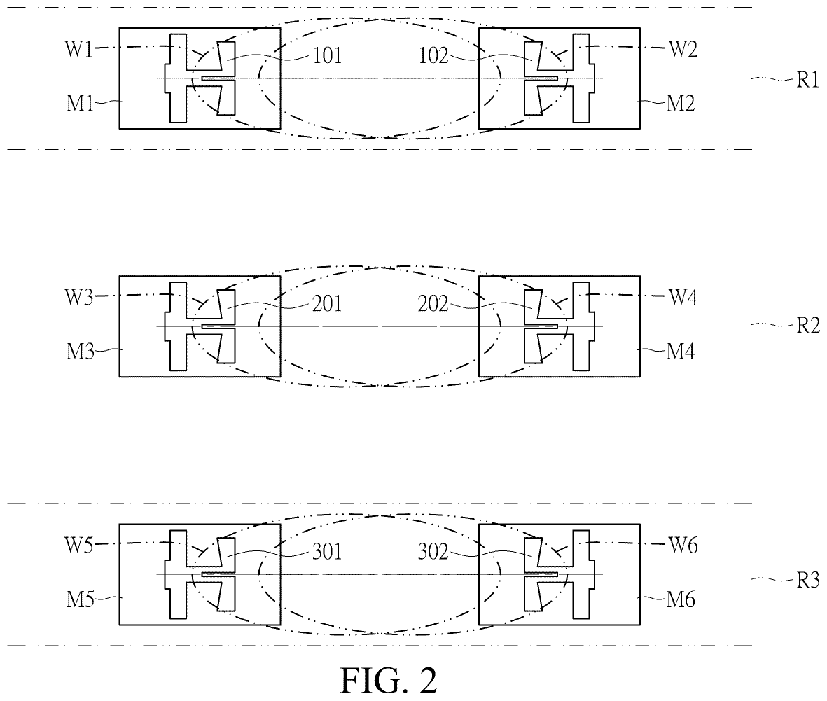

FIG. 2 is a schematic diagram of the main beam of the antenna system in FIG. 1. Referring to FIG. 1 and FIG. 2, according to the seating configuration of the vehicle V, multiple areas are appropriately arranged, for example, the interior of the vehicle V is sequentially divided into a first area R1, a second area R2, and a third area R3 from the front to the rear, with the second area R2 located between the first area R1 and the third area R3. The first area R1 is equipped with multiple seats arranged from the left side to the right side of the vehicle V (not shown in the figure), the second area R2 is equipped with multiple seats arranged from the left side to the right side of the vehicle V, and the third area R3 is equipped with multiple seats arranged from the left side to the right side of the vehicle V. The first antenna pair 10, the second antenna pair 20, and the third antenna pair 30 are respectively located in the first area R1, the second area R2, and the third area R3.

When the first transmitter switch 11 and the first receiver switch 12 are in a conductive state, the second transmitter switch 21, the second receiver switch 22, the third transmitter switch 31, and the third receiver switch 32 are in a non-conductive state. At this time, the main beam W1 of the first transmitter antenna 101 passes through the first area R1, the main beam W2 of the first receiver antenna 102 passes through the first area R1, and the main beam W1 and the main beam W2 overlap in the first area R1.

The first receiver antenna 102 receives a first Wi-Fi signal from the first transmitter antenna 101, and the first receiver antenna 102 transmits the first Wi-Fi signal to the wireless receiving circuit 5.

When the wireless receiving circuit 5 receives the first Wi-Fi signal, the channel state information capturing circuit of the wireless receiving circuit 5 obtains the first channel state information of the first Wi-Fi signal, and the first channel state information is related to the first spatial information of the first area R1. Specifically, when the first spatial information of the first area R1 changes, the first channel state information also changes accordingly.

The wireless receiving circuit 5 is network-connected to a host H and transmits the first channel state information to the host H, where the host H may be a computer or a server. The host H analyzes the first channel state information to obtain the first spatial information of the first area R1.

When the second transmitter switch 21 and the second receiver switch 22 are in the conductive state, the first transmitter switch 11, the first receiver switch 12, the third transmitter switch 31, and the third receiver switch 32 are in the non-conductive state. At this time, the main beam W3 of the second transmitter antenna 201 passes through the second area R2, the main beam W4 of the second receiver antenna 202 passes through the second area R2, and the main beam W3 and the main beam W4 overlap in the second area R2.

The second receiver antenna 202 receives a second Wi-Fi signal from the second transmitter antenna 201, and the second receiver antenna 202 transmits the second Wi-Fi signal to the wireless receiving circuit 5.

The wireless receiving circuit 5 obtains the second channel state information of the second Wi-Fi signal, and the second channel state information is related to the second spatial information of the second area R2. The host H analyzes the second channel state information to obtain the second spatial information of the second area R2.

When the third transmitter switch 31 and the third receiver switch 32 are in the conductive state, the first transmitter switch 11, the first receiver switch 12, the second transmitter switch 21, and the second receiver switch 22 are in the non-conductive state. At this time, the main beam W5 of the third transmitter antenna 301 passes through the third area R3, the main beam W6 of the third receiver antenna 302 passes through the third area R3, and the main beam W5 and the main beam W6 overlap in the third area R3.

The third receiver antenna 302 receives the third Wi-Fi signal from the third transmitter antenna 301, and the third receiver antenna 302 transmits the third Wi-Fi signal to the wireless receiving circuit 5.

The wireless receiving circuit 5 obtains the third channel state information of the third Wi-Fi signal, and the third channel state information is related to the third spatial information of the third area R3. The host H analyzes the third channel state information to obtain the third spatial information of the third area R3.

Regarding the method for analyzing channel state information, for example, the host H can convert the channel state information into the amplitude and phase of electromagnetic waves and determine the seating status for each seat within the area based on the amplitude and phase. Specifically, the seating status includes unoccupied, occupied by an adult, and occupied by a child.

From the main beam diagram in FIG. 2, it can be seen that when the first antenna pair 10, the second antenna pair 20, and the third antenna pair 30 are sequentially switched for use, the interior space of the vehicle V is partitioned into the first area R1, the second area R2, and the third area R3, enabling the obtaining of the first spatial information for the first area R1, the second spatial information for the second area R2, and the third spatial information for the third area R3.

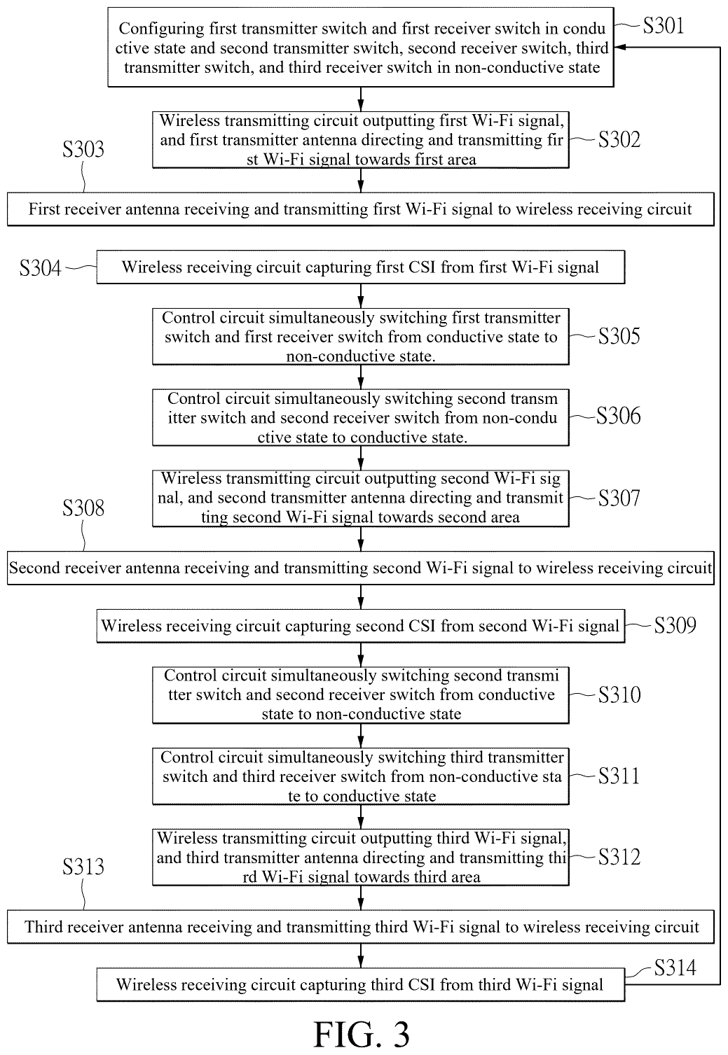

FIG. 3 is a flowchart of an embodiment of an antenna detection method according to the present disclosure, and the antenna detection method in FIG. 3 can be executed by the antenna system in FIG. 1.

As shown in FIG. 3, in step S301, the first transmitter switch 11 and the first receiver switch 12 are configured to be in the conductive state, and the second transmitter switch 21, the second receiver switch 22, the third transmitter switch 31, and the third receiver switch 32 are configured to be in the non-conductive state.

In step S302, the wireless transmitting circuit 4 outputs the first Wi-Fi signal, and the first transmitter antenna 101 directs and transmits the first Wi-Fi signal towards the first area R1.

In step S303, the first receiver antenna 102 receives the first Wi-Fi signal and transmits the first Wi-Fi signal to the wireless receiving circuit 5.

In step S304, the wireless receiving circuit 5 captures the first channel state information from the first Wi-Fi signal.

In step S305, the control circuit 6 simultaneously switches the first transmitter switch 11 and the first receiver switch 12 from the conductive state to the non-conductive state.

In step S306, the control circuit 6 simultaneously switches the second transmitter switch 21 and the second receiver switch 22 from the non-conductive state to the conductive state.

In step S307, the wireless transmitting circuit 4 outputs the second Wi-Fi signal, and the second transmitter antenna 201 directs and transmits the second Wi-Fi signal towards the second area R2.

In step S308, the second receiver antenna 202 receives the second Wi-Fi signal and transmits the second Wi-Fi signal to the wireless receiving circuit 5.

In step S309, the wireless receiving circuit 5 captures the second channel state information from the second Wi-Fi signal.

In step S310, the control circuit 6 simultaneously switches the second transmitter switch 21 and the second receiver switch 22 from the conductive state to the non-conductive state.

In step S311, the control circuit 6 simultaneously switches the third transmitter switch 31 and the third receiver switch 32 from the non-conductive state to the conductive state.

In step S312, the wireless transmitting circuit 4 outputs the third Wi-Fi signal, and the third transmitter antenna 301 directs and transmits the third Wi-Fi signal towards the third area R3.

In step S313, the third receiver antenna 302 receives the third Wi-Fi signal and transmits the third Wi-Fi signal to the wireless receiving circuit 5.

In step S314, the wireless receiving circuit 5 captures the third channel state information from the third Wi-Fi signal, and then the process returns to step S301.

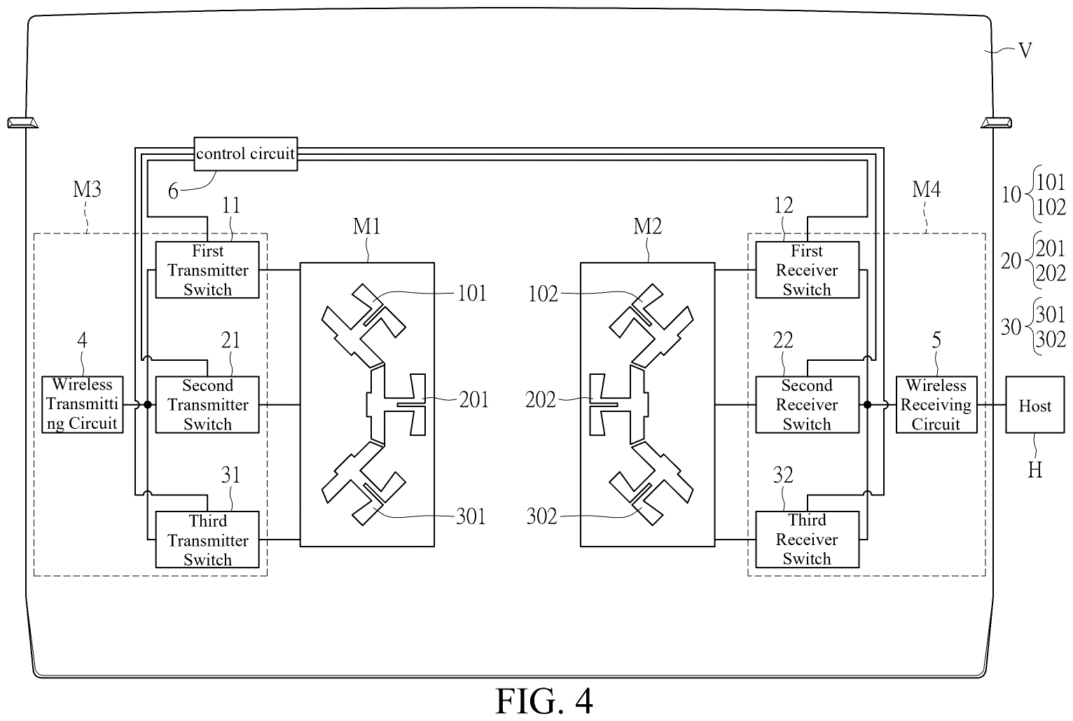

FIG. 4 is a schematic diagram of a second embodiment of the antenna system according to the present disclosure, and the difference between FIG. 4 and FIG. 1 is as follows.

The first transmitter antenna 101, the second transmitter antenna 201, and the third transmitter antenna 301 are disposed on the first circuit substrate M1, while the first receiver antenna 102, the second receiver antenna 202, and the third receiver antenna 302 are disposed on the second circuit substrate M2. The first transmitter switch 11, the second transmitter switch 21, and the third transmitter switch 31 are disposed on the third circuit substrate M3, while the first receiver switch 12, the second receiver switch 22, and the third receiver switch 32 are disposed on the fourth circuit substrate M4.

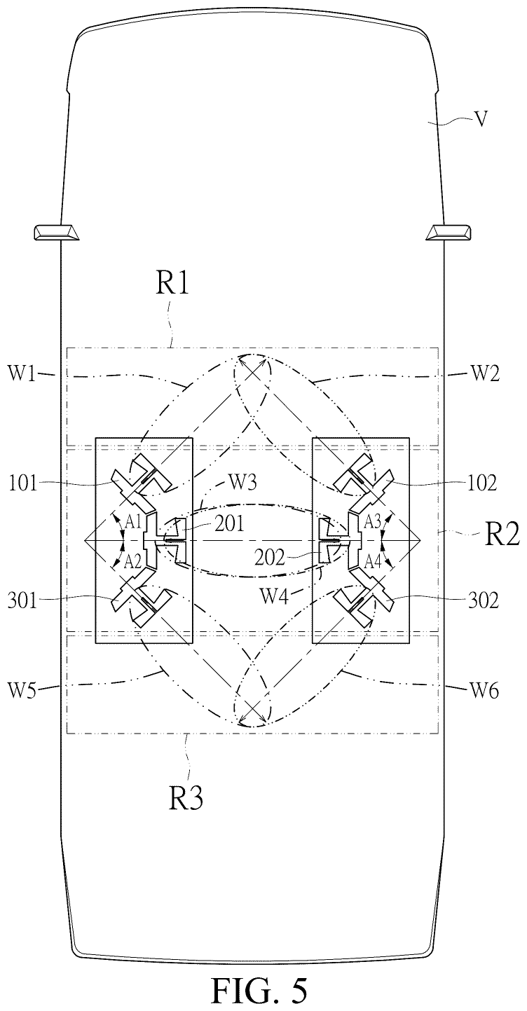

FIG. 5 is a schematic diagram of the main beam of the antenna system in FIG. 4. As shown in FIG. 5, the main beam W1 of the first transmitter antenna 101 passes through the first area R1 and the second area R2, and the main beam W2 of the first receiver antenna 102 passes through the first area R1 and the second area R2. The main beam W1 and the main beam W2 overlap in the first area R1.

The main beam W3 of the second transmitter antenna 201 passes through the second area R2, and the main beam W4 of the second receiver antenna 202 passes through the second area R2. The main beam W3 and the main beam W4 overlap in the second area R2.

The main beam W5 of the third transmitter antenna 301 passes through the second area R2 and the third area R3, and the main beam W6 of the third receiver antenna 302 passes through the second area R2 and the third area R3. The main beam W5 and the main beam W6 overlap in the third area R3.

Preferably, the first antenna pair 10, the second antenna pair 20, and the third antenna pair 30 may all be directional antennas, or some of them may be directional antennas.

When the first transmitter antenna 101, the second transmitter antenna 201, and the third transmitter antenna 301 are directional antennas, the first transmitter antenna 101, the second transmitter antenna 201, and the third transmitter antenna 301 can each have a signal transmission direction (for example, the direction indicated by the main beam in the antenna pattern).

The signal transmission directions of the first transmitting antenna 101 and the second transmitting antenna 201 form a first angle A1, and the signal transmission directions of the third transmitting antenna 301 and the second transmitting antenna 201 form a second angle A2. The first angle A1 may be equal to or approximate to the second angle A2.

The signal transmission directions of the first receiver antenna 102 and the second receiver antenna 202 form a third angle A3, and the signal transmission directions of the third receiver antenna 302 and the second receiver antenna 202 form a fourth angle A4. The third angle A3 may be equal to or approximate to the fourth angle A4.

From the main beam diagram in FIG. 5, it can be seen that when the first antenna pair 10, the second antenna pair 20, and the third antenna pair 30 are sequentially switched for use, the interior space of the vehicle V is partitioned into the first area R1, the second area R2, and the third area R3, enabling the obtaining of the first spatial information of the first area R1, the second spatial information of the second area R2, and the third spatial information of the third area R3.

Thus, the cost of antenna assembly and the cost of antennas can be reduced.

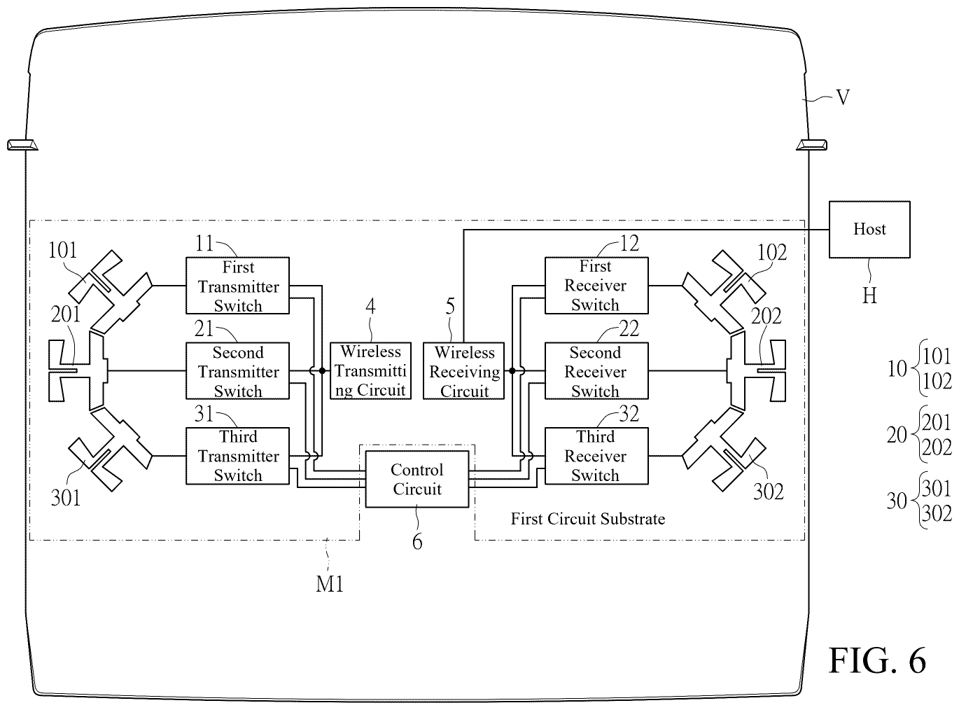

FIG. 6 is a schematic diagram of a third embodiment of the antenna system according to the present disclosure, and the difference between FIG. 6 and FIG. 1 is as follows.

The first antenna pair 10, the second antenna pair 20, the third antenna pair 30, the first transmitter switch 11, the second transmitter switch 21, the third transmitter switch 31, the first receiver switch 12, the second receiver switch 22, the third receiver switch 32, the wireless transmitting circuit 4, and the wireless receiving circuit 5 are all disposed on the first circuit substrate M1. The wireless transmitting circuit 4 and the wireless receiving circuit 5 can share the same central processing unit.

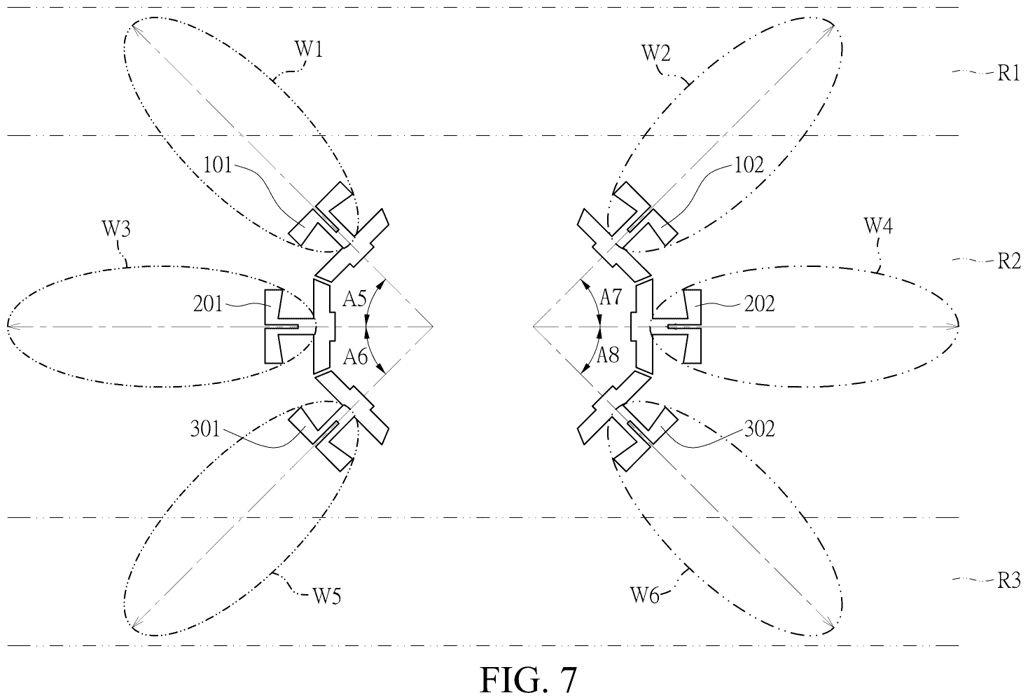

FIG. 7 is a schematic diagram of the main beam of the antenna system in FIG. 6. As shown in FIG. 7, the main beam W1 of the first transmitter antenna 101 passes through the first area R1 and the second area R2, and the main beam W2 of the first receiver antenna 102 passes through the first area R1 and the second area R2.

The main beam W3 of the second transmitter antenna 201 passes through the second area R2, and the main beam W4 of the second receiver antenna 202 passes through the second area R2.

The main beam W5 of the third transmitter antenna 301 passes through the second area R2 and the third area R3, and the main beam W6 of the third receiver antenna 302 passes through the second area R2 and the third area R3.

When functioning as directional antennas, the signal transmission directions of the first transmitting antenna 101 and the second transmitting antenna 201 form a fifth angle A5, and the signal transmission directions of the third transmitting antenna 301 and the second transmitting antenna 201 form a sixth angle A6. The fifth angle A5 may be equal to or approximate to the sixth angle A6.

The signal transmission directions of the first receiving antenna 102 and the second receiving antenna 202 form a seventh angle A7, and the signal transmission directions of the third receiving antenna 302 and the second receiving antenna 202 form an eighth angle A8. The seventh angle A7 may be equal to or approximate to the eighth angle A8.

From the main beam diagram in FIG. 7, it can be seen that when the first antenna pair 10, the second antenna pair 20, and the third antenna pair 30 are switched and used in sequence, the interior space of the vehicle V can also be partitioned into the first area R1, the second area R2, and the third area R3. Thus, the cost of antenna assembly and the cost of antennas can be reduced.

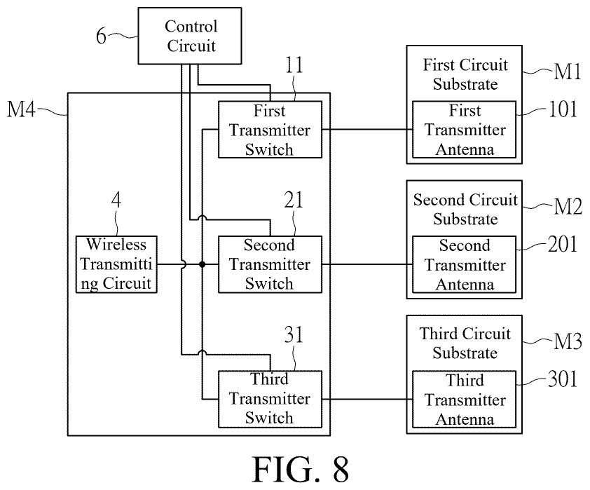

FIG. 8 is a schematic diagram of a first embodiment of an antenna device according to the present disclosure. Referring to FIG. 1 and FIG. 8, the antenna device in FIG. 8 is part of the antenna system shown in FIG. 1.

The antenna device includes the first transmitter antenna 101, the second transmitter antenna 201, the third transmitter antenna 301, the first transmitter switch 11, the second transmitter switch 21, the third transmitter switch 31, the wireless transmitting circuit 4, and the control circuit 6.

The first transmitter antenna 101, the second transmitter antenna 201, and the third transmitter antenna 301 are respectively three directional antennas, and the first transmitter antenna 101, the second transmitter antenna 201, and the third transmitter antenna 301 are respectively disposed on the first circuit substrate M1, the second circuit substrate M2, and the third circuit substrate M3.

The first transmitter switch 11, the second transmitter switch 21, and the third transmitter switch 31 are respectively coupled to the first transmitter antenna 101, the second transmitter antenna 201, and the third transmitter antenna 301.

The first transmitter switch 11, the second transmitter switch 21, the third transmitter switch 31, and the wireless transmitting circuit 4 are disposed on the fourth circuit substrate M4. The wireless transmitting circuit 4 is a Wi-Fi signal transmitting circuit, and the wireless transmitting circuit 4 is coupled to the first transmitter switch 11, the second transmitter switch 21, and the third transmitter switch 31. The control circuit 6 is coupled to the first transmitter switch 11, the second transmitter switch 21, and the third transmitter switch 31.

The control circuit 6 sequentially switches the first transmitter switch 11, the second transmitter switch 21, and the third transmitter switch 31, enabling the first transmitter antenna 101, the second transmitter antenna 201, and the third transmitter antenna 301 to sequentially transmit the first Wi-Fi signal, the second Wi-Fi signal, and the third Wi-Fi signal.

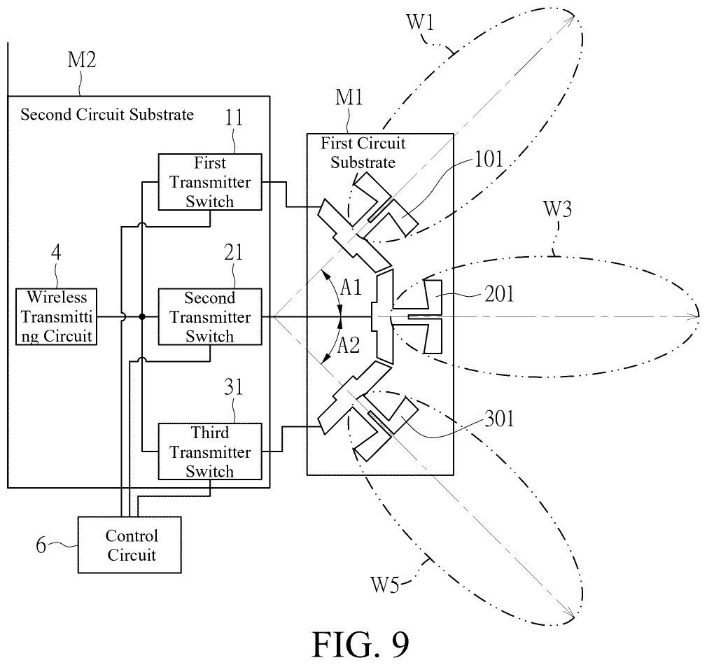

FIG. 9 is a schematic diagram of a second embodiment of the antenna device according to the present disclosure, and the difference between FIG. 9 and FIG. 8 is as follows.

The first transmitter antenna 101, the second transmitter antenna 201, and the third transmitter antenna 301 are disposed on the first circuit substrate M1, and the first transmitter switch 11, the second transmitter switch 21, and the third transmitter switch 31 are disposed on the second circuit substrate M2.

The signal transmission directions of the first transmitter antenna 101 and the second transmitter antenna 201 form a first angle A1. Similarly, the signal transmission directions of the third transmitter antenna 301 and the second transmitter antenna 201 form a second angle A2. The first angle A1 can be equal to or approximate to the second angle A2. Thus, the cost of antenna assembly and the cost of antennas can be reduced.

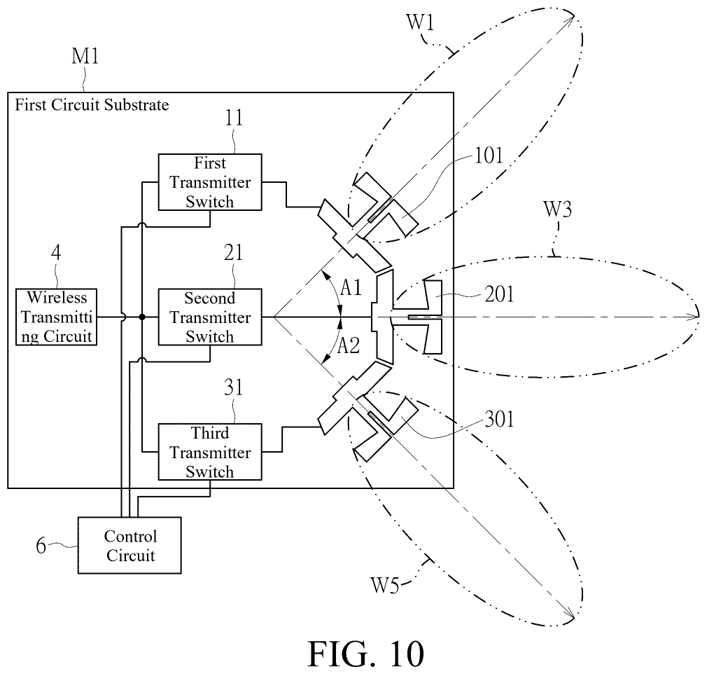

FIG. 10 is a schematic diagram of a third embodiment of the antenna device according to the present disclosure, and the difference between FIG. 10 and FIG. 8 is that the first transmitter antenna 101, the second transmitter antenna 201, the third transmitter antenna 301, the first transmitter switch 11, the second transmitter switch 21, the third transmitter switch 31, and the wireless transmitting circuit 4 are all disposed on the first circuit substrate M1. The signal transmission directions of the first transmitter antenna 101 and the second transmitter antenna 201 form a first angle A1, the signal transmission directions of the third transmitter antenna 301 and the second transmitter antenna 201 form a second angle A2, and the first angle A1 can be equal to or approximate to the second angle A2. Thus, the cost of antenna assembly and the cost of antennas can be reduced.

### Benefits of the Embodiments

One of the beneficial effects of the present disclosure is that the antenna system, antenna detection method, and antenna device provided by the present disclosure can obtain channel state information of each area within the field. Based on the analysis of the channel state information, spatial information of each area can be obtained. By obtaining the spatial information of each area, it is possible to determine whether the personnel in each area are children or adults and their respective locations, while also reducing the complexity of the algorithm.

Another beneficial effect of the present disclosure is that the antenna system, antenna detection method, and antenna device provided by the present disclosure can be applied to the interior environment of a vehicle (in-vehicle environment). Through the configuration of multiple antenna pairs and Wi-Fi sensing technology, the vehicle interior environment can be partitioned into multiple areas, and the channel state information of each area can be obtained, thereby determining the passenger positions and combinations in each area.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna system, suitable for a field, comprising:
a plurality of antenna pairs, each of the plurality of antenna pairs comprising a transmitter antenna and a receiver antenna;
a plurality of transmitter switches coupled to the plurality of transmitter antennas, respectively;
a plurality of receiver switches coupled to the plurality of receiver antennas, respectively; and
a wireless receiving circuit coupled to the plurality of receiver switches;
wherein the plurality of transmitter switches and the plurality of receiver switches are sequentially switched, and the transmitter switch and the receiver switch that are coupled to the same antenna pair are synchronously switched;
wherein the wireless receiving circuit is configured to sequentially receive a plurality of wireless signals, and the plurality of wireless signals respectively include a plurality of records of spatial information for multiple areas within the field.

2. The antenna system according to claim 1, further comprising a wireless transmitting circuit, wherein the wireless transmitting circuit is coupled to the plurality of transmitter switches, the wireless transmitting circuit is a Wi-Fi signal transmitting circuit, and the wireless receiving circuit is a Wi-Fi signal receiving circuit, the wireless receiving circuit captures a plurality of records of channel state information from the plurality of wireless signals, and the plurality of records of channel state information are respectively related to the plurality of records of spatial information.

3. The antenna system according to claim 1, wherein the plurality of transmitter antennas and the plurality of receiver antennas are a plurality of directional antennas.

4. The antenna system according to claim 2, wherein each of the plurality of wireless signals is a Wi-Fi signal, the field is an interior of a vehicle, and the wireless receiving circuit receives the Wi-Fi signals in each of the multiple areas to obtain the channel state information.

5. The antenna system according to claim 1, wherein an isolation between two adjacent transmitter antennas is greater than 30 decibels, and an isolation between two adjacent receiver antennas is greater than 30 decibels.

6. The antenna system according to claim 1, wherein the plurality of transmitter antennas and the plurality of receiver antennas are respectively disposed on a plurality of different circuit substrates.

7. The antenna system according to claim 1, wherein the plurality of transmitter antennas are disposed on a first circuit substrate, and the plurality of receiver antennas are disposed on a second circuit substrate.

8. The antenna system according to claim 1, further comprising a wireless transmitting circuit, wherein the plurality of transmitter antennas, the plurality of receiver antennas, the plurality of transmitter switches, the plurality of receiver switches, the wireless transmitting circuit, and the wireless receiving circuit are disposed on a first circuit substrate.

9. The antenna system according to claim 1, further comprising a control circuit, wherein the control circuit is coupled to the plurality of transmitter switches and the plurality of receiver switches.

10. An antenna detection method, suitable for a field, comprising:
configuring a plurality of antenna pairs, each of the plurality of antenna pairs comprising a transmitter antenna and a receiver antenna, and the transmitter antenna and the receiver antenna of each of the plurality of antenna pairs are respectively coupled to a transmitter switch and a receiver switch;
sequentially switching the plurality of transmitter switches and the plurality of receiver switches by synchronously switching the transmitter switch and the receiver switch coupled to the same antenna pair;
sequentially transmitting a plurality of wireless signals from the plurality of transmitter antennas to the plurality of receiver antennas; and
sequentially receiving the plurality of wireless signals via a wireless receiving circuit, wherein the plurality of wireless signals respectively include a plurality of records of spatial information for multiple areas within the field.

11. The antenna detection method according to claim 10, wherein the wireless transmitting circuit is a Wi-Fi signal transmitting circuit, and the wireless receiving circuit is a Wi-Fi signal receiving circuit.

12. The antenna detection method according to claim 10, wherein the plurality of antenna pairs are respectively disposed in the multiple areas.

13. The antenna detection method according to claim 10, wherein the plurality of transmitter switches are respectively switched at a plurality of switching times, and the plurality of switching times have equal time intervals.

14. An antenna device comprising:
a wireless transmitting circuit;
a plurality of transmitter switches coupled to the wireless transmitting circuit; and
a plurality of transmitter antennas respectively coupled to the plurality of transmitter switches;
wherein the plurality of transmitter switches are configured to be sequentially switched.

15. The antenna device according to claim 14, wherein the wireless transmitting circuit is a Wi-Fi signal transmitting circuit.

16. The antenna device according to claim 14, wherein the plurality of transmitter antennas are a plurality of directional antennas.

17. The antenna device according to claim 14, wherein the plurality of transmitter antennas are respectively disposed on a plurality of different circuit substrates.

18. The antenna device according to claim 14, wherein the plurality of transmitter antennas are disposed on a circuit substrate.

19. The antenna device according to claim 14, wherein the wireless transmitting circuit, the plurality of transmitter switches, and the plurality of transmitter antennas are disposed on a circuit substrate.
